(19) United States
(12) Patent Application Publication
(10) Pub. No.: US 2022/0114560 A1
(43) Pub. Date: Apr. 14, 2022

(54) PREDICTIVE MAINTENANCE

(71) Applicant: ExxonMobil Research and Engineering Company, Annandale, NJ (US)

(72) Inventors: Eric B. Senzer, Margate, FL (US); Samuel C. Bainbridge, Philadelphia, PA (US)

(21) Appl. No.: 17/287,622

(22) PCT Filed: Nov. 12, 2019
(86) PCT No.: PCT/US2019/060809

§ 371 Date: Apr. 22, 2021

Related U.S. Application Data
(60) Provisional application No. 62/771,343, filed on Nov. 26, 2018.

(51) Int. Cl. G06Q 10/00; G07C 5/08

(52) U.S. Cl. CPC G06Q 10/20; G07C 5/085; G07C 5/0816

(57) ABSTRACT

Aspects of the technology described herein improve a computing device's ability to accurately extract contextual features related to vehicle performance, vehicle usage, maintenance, recalls, and use the information to provide maintenance recommendations. Aspects of the technology described herein can analyze vehicle data from multiple sources including vehicle sensors, driver computing devices, maintenance records, used oil analysis, aftermarket sensors, and other data sources to ascertain a vehicle's operational state and detect warning signs that are statistically correlated with a mechanical failure or unsafe driving condition. When a warning sign is detected, the technology described herein can make maintenance suggestions to decrease the vehicle's failure probability. The maintenance suggestions can be generated by analyzing data from historical vehicle data to identify actions that improved the operational state for the same vehicle and/or similar vehicles.

### FIELD

Optimizing the timing and substance of vehicle maintenance.

### BACKGROUND

Both individual operators/owners and large fleet managers seek to optimize vehicle maintenance to maximize a vehicle's operational availability. Too much maintenance reduces vehicle availability because a vehicle cannot be operated during maintenance events. Too little maintenance will result in mechanical failures that could have been avoided with proper maintenance. Therefore, there is an optimum balance between performing routine maintenance on the vehicle at scheduled intervals and repairing vehicles before unanticipated failures occur. Repairing these unanticipated failures is often more expensive and more time consuming than regular maintenance or repairing the component ahead of time.

The existing technology seeks to optimize maintenance by finding patterns and correlations between the vehicle's condition (past and present), performed maintenance (and any associated repairs), and used oil analysis. The vehicle conditions may be monitored in real-time or near-real-time. For example, U.S. Pat. No. 9,881,428 describes a system that analyzes vehicle data to predict failures. The vehicle data can include alerts from the on-board diagnostic system. See '428 patent Abstract.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the technology described herein improve a computing device's ability to accurately extract contextual features related to vehicle performance, vehicle usage, maintenance, and recalls, and use the information to provide maintenance recommendations. Aspects of the technology described herein can analyze vehicle data from multiple sources including vehicle sensors, driver computing devices, maintenance records, used oil analysis, aftermarket sensors, and other data sources to ascertain a vehicle's operational state and detect warning signs that are statistically correlated with a mechanical failure or unsafe driving condition. When a warning sign is detected, the technology described herein can make maintenance suggestions to decrease the vehicle's failure probability. The maintenance suggestions can be generated by analyzing data from past maintenance operations to identify actions that improved the operational state for the same vehicle and/or similarly situated vehicles.

In addition to maintenance suggestions, the estimated operational life can be estimated for a vehicle at a given time. The operational life is the amount of use left in the vehicle before a failure is likely to occur or an unsafe condition is likely to develop. The maintenance suggestion can include the estimated operational life of the vehicle to help the recipient of the notification schedule the suggested maintenance in an appropriate time frame.

Further, aspects of the technology can reduce the need for maintenance by identifying usage incidents or usage patterns that contribute to the need to perform the maintenance. Suggestions for avoiding the usage incidents may be provided.

### BRIEF DESCRIPTION OF THE DRAWINGS

The technology described herein is illustrated by way of example and not limitation in the accompanying figures in which like reference numerals indicate similar elements and in which:

FIG. 1 is a block diagram of an example operating environment suitable for implementations of the present disclosure;

FIG. 2 is a diagram depicting an example computing architecture suitable for implementing aspects of the present disclosure;

FIG. 3 is a figure showing an operational state interface, in accordance with an aspect of the technology described herein;

FIGS. 4-6 are flow diagrams showing exemplary methods of determining the operational state of a vehicle, in accordance with an aspect of the technology described herein; and

FIG. 7 is a block diagram of an exemplary computing environment suitable for use in implementing aspects of the technology described herein.

### DETAILED DESCRIPTION

The various technology described herein are set forth with sufficient specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the technology described herein improve a computing device's ability to accurately extract contextual features related to vehicle performance, vehicle usage, maintenance, and recalls, and use the information to provide maintenance recommendations. Aspects of the technology described herein can analyze vehicle data from multiple sources including vehicle sensors, driver computing devices, maintenance records, used oil analysis, aftermarket sensors, and other data sources to ascertain a vehicle's operational state and detect warning signs that are statistically correlated with a mechanical failure or unsafe driving condition. When a warning sign is detected, the technology described herein can make maintenance suggestions to decrease the vehicle's failure probability. The maintenance suggestions can be generated by analyzing data from past maintenance operations to identify actions that improved the operational state for the same vehicle and/or similarly situated vehicles.

Aspects of the technology described herein can measure a vehicle's operational state and suggest remedies to restore the vehicle's operational state to a desired level. As used herein, operational state refers to a statistical probability that a vehicle will experience a failure that prevents use or causes an unsafe operating condition (e.g., worn tires or brake pads). The failure can be for any system in the vehicle and includes both mechanical and electrical failures. The unsafe operating condition can be defined by a company representative, government regulations, trade organization guidelines, driver preference, observed statistical correlation with failure, or other persons associated with a vehicle.

As used herein, the operational state of a vehicle is the vehicle's physical condition at a point in time. The operational state of various components may also be determined.

As used herein, an operational-state score is a measure of the operational state of a vehicle generated by a machine learning system using vehicle data. Vehicle data is described below in detail and can take many forms including maintenance records, operational data, performance characteristics, and component measurements.

As used herein, the operational usage (also described as vehicle usage) of a vehicle describes how the vehicle is used. The load on the vehicle, the route taken, the weather experiences, the traffic experiences, and how the vehicle is driven are all examples of operational usage.

As used herein, downtime is a period of time when a vehicle cannot be used for its intended purpose because maintenance or repair is required. For example, if the transmission in a van failed, the downtime for the van would start at the time the transmission failed and the point in time when the transmission and any associated damage was repaired. During this time, the van may not be driven, which is the van's intended purpose.

Aspects of the technology can provide an overall operational-state score and/or a component-by-component operational-state score. When available, directly measured data that contributed to the score, such as low tread depth, may be provided with the score. For example, tread depth, tire inflation, tire mileage, alignment records, vehicle usage data, driver habits, and other data can be analyzed to determine an operational state of one or more tires on a vehicle. The operational state of an individual component, such as a tire, can be output to a user in terms of an overall score. The score can be expressed on a scale, such as between 1 and 10 or in colors like green, yellow, and red. In some cases, the score can also be presented with an operational parameter. For example, the operational-state score notification for a tire could state that 5,000 miles of tread life are available. The score notification could also reflect a measured condition, such as coolant level is 1 liter below the low limit.

Similarly, an overall operational state for a vehicle can be calculated. In aspects, the overall operational state can be calculated by combining the operational state of various vehicle components. The operational state of different components can be given different weights based on the downtime, replacement cost, and/or other consequences that may result from a failure of the component. Failures that will result in longer downtime and/or higher cost can be given more weight. The weights can be editorially assigned by a user or learned through machine learning processes, such as a deep neural network. Alternatively, the overall operational-state score can be calculated by analysis of vehicle data without calculating individual component operational-state scores.

In addition to maintenance suggestions, the operational life can be estimated for a vehicle at a given time. The operational life is the amount of use left in the vehicle before a failure is likely to occur or an unsafe condition is likely to develop. The maintenance suggestion can include the estimated operational life of the vehicle to help the recipient of the notification schedule the suggested maintenance in an appropriate time frame.

Further, aspects of the technology can reduce the need for maintenance by identifying usage incidents or usage patterns that contribute to the need to perform the maintenance. Suggestions for avoiding the usage incidents may be provided.

The remedies for a predicted failure can include suggested maintenance at a specified time (optimized for the fleet's operations), maintenance prioritization, driver training, changes in route (e.g., for immediate maintenance or attention requirements) or other operational parameters, or a combination of the above. Using the tire example above, the direct tire measurements, such as tread depth, and vehicle usage data, such as might be collected from an accelerometer, GPS data, gyroscope, microphones, or other signal collection components present in the vehicle, may indicate the tires are likely to fail soon. The remedy can be to replace the tires but also retrain a driver that has been observed to habitually accelerate and/or brake rapidly. Similarly, it may be observed through onboard signal collection, road reports, government studies, or other data that Bainbridge Road is in good repair and should be traveled on every time to preserve tire life, in contrast to alternative routes with potholes. When travel on a road in poor repair is observed, then an alternative route could be suggested.

The operational-state score can be calculated using operation event records. An operation event describes an occurrence that can be detected from a single signal or a combination of multiple signals received from computing devices, such as a vehicle computing system, driver's personal computers, and such. Event types can include driving mishaps, such as skidding events and brake lock events. Other event types include loading events, weather events, traffic events, vehicle stress events as measured by collection of vehicle use parameters (e.g., speed, load), and such. The signals can come from sensors on board the vehicle. A signal analysis can be used to determine when an operation event has occurred. For example, an emergency braking event can be identified by analyzing accelerometer data from a vehicle sensor with vehicle telemetry indicating the brakes were applied. A cold weather driving event can be determined using time-stamped GPS data from the vehicle with weather reports retrieved from a weather data source that is correlated to the GPS data.

The signals can also be from maintenance records, including analysis/replacement/repair of parts (e.g., tires, brake pads). The signals can also describe fluid analysis (e.g., used oil analysis) of samples removed/taken during routine and non-routine maintenance events. The maintenance data can be stored as maintenance events. Each maintenance event can be associated with a date, duration (i.e., total downtime), expense, and explanation of maintenance performed, including a record of measured vehicle parameters at the time of the event (such as odometer readings). The associated contextual data for each maintenance event can also be applied to the analyzed parameters of the removed fluids, such as an analysis of oil sampled from a vehicle. The maintenance events can be stored in maintenance record store 244 of the vehicle profile 240.

Each identified event can be associated with contextual information directly related to the event, as well as peripheral contextual information describing other activities in a vehicle's day or driver's day that are not directly related to the event. The direct contextual information associated with an event can comprise a location where the event occurred, duration of the event, physiological characteristics of a driver (e.g., elevated heart rate) associated with the event, the presence of other people during the event, and such. The direct contextual information can be learned through analysis of user or vehicle data captured during the event. The peripheral contextual information can include a description of a vehicle's and/or user's activities during the day, days, and hours before or after an event.

An event record can be created by analyzing multiple signals to confirm an event actually occurred. Aspects of the technology can combine signals from multiple sources to eliminate false positives that occur when only one signal is used to determine whether an event occurred. For example, location or other contextual data could be used to cross-check onboard temperature sensor data and onboard sensor data can be used to cross-check location and other contextual data. In isolation, either of these signals can produce false positives (an event that would be classified as “cold weather” event, but the vehicle did not actually drive through cold weather). In this scenario, the onboard signal data indicating a possible “cold weather” event is disambiguated using location data provided by the driver's smartphone or installed telematics device (e.g., a data logger with GPS capabilities) to conclude that a cold weather event has not occurred by looking at weather records for the location at the time of the event. However, when the vehicle data for multiple devices is consistent with a type of event, then an event description can be generated and stored in an event data store.

“Contextual signals,” as utilized herein, may reflect any attribute of a vehicle (e.g., speed, mileage, vibrations) and/or user (for instance, physical characteristics), the user's historical interaction with the vehicle (e.g., behavior, driving habits, and system interaction patterns), and/or the user's recent interaction with the vehicle (with “recent” being defined in accordance with a predetermined time frame relative to a given point in time). Such contextual signals may include, by way of example only and not limitation, the location of the user of the computing device (determined utilizing, for instance, Global Positioning System (GPS) signals, Internet Protocol (IP) address, or the like), the time of day (either general (for instance, morning or afternoon) or exact (for instance, 6:00:01 pm)), the date (either exact or generally a particular month, season, etc.), a physical characteristic of the user (for instance, if the user is left handed), a task currently engaged in on the computing device by the user, a task recently engaged in on the computing device by the user (again with “recent” being defined in accordance with a predetermined time frame relative to a given point in time), an object the user is currently engaged with on the computing device (for instance, an entity such as a route map, delivery record, a file, an image, or the like), and an object the user was recently engaged with on the computing device.

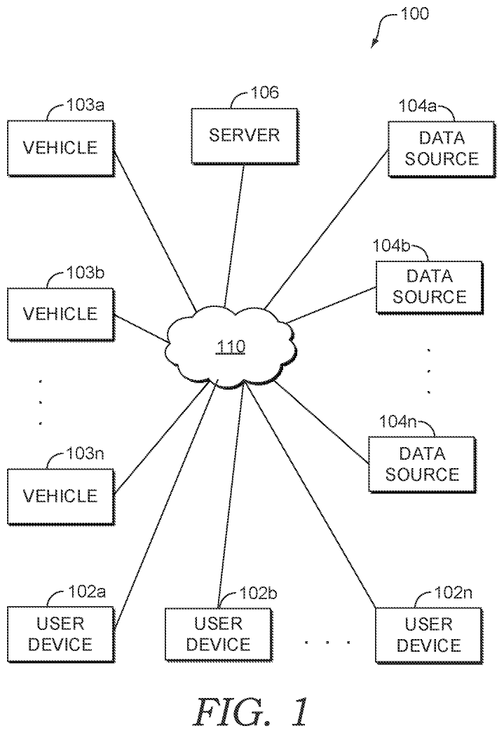

Having briefly described an overview of aspects of the technology described herein, an exemplary operating environment in which aspects of the technology described herein may be implemented is described below in order to provide a general context for various aspects. Referring to the figures in general and initially to FIG. 1 in particular, an exemplary operating environment for implementing technology described herein is shown and designated generally as exemplary operating environment 100. The exemplary operating environment 100 is but one example of a suitable computing environment and is not intended to suggest any limitation as to the scope of use or functionality of aspects of the technology described herein. Neither should the exemplary operating environment 100 be interpreted as having any dependency or requirement relating to any one component nor any combination of components illustrated.

Turning now to FIG. 1, a block diagram is provided showing an example operating environment 100 in which some aspects of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

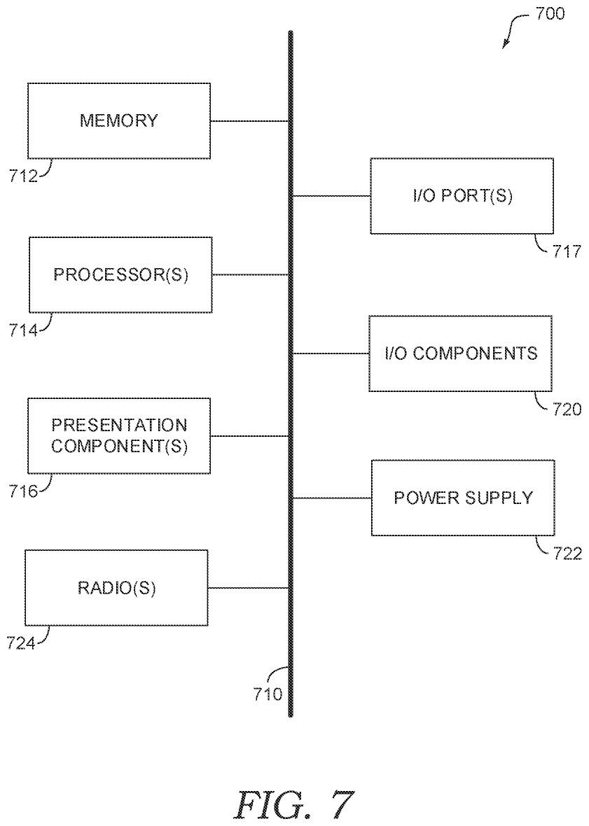

Among other components not shown, example operating environment 100 includes a number of user devices, such as user devices 102a and 102b through 102n; a number of data sources, such as data sources 104a and 104b through 104n; a number of vehicles, such as vehicles 103a and 103b through 103n; server 106; and network 110. It should be understood that environment 100 shown in FIG. 1 is an example of one suitable operating environment. Each of the components shown in FIG. 1 may be implemented via any type of computing device, such as computing device 700 described in connection to FIG. 7. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks. The communications occurring over network 110 can utilize various wireless communication protocols.

User devices 102a and 102b through 102n and vehicles 103a and 103b through 103n can be client devices on a client-side of operating environment 100, while server 106 can be on the server-side of operating environment 100. The user devices can be associated with drivers, passengers, fleet managers, maintenance specialists, or other people associated directly or indirectly with a vehicle. The signals from the user device, vehicles, and data sources can be analyzed to determine a vehicle's operational state. Server 106 can comprise server-side software designed to work in conjunction with client-side software on user devices 102a and 102b through 102n so as to implement any combination of the features and functionalities discussed in the present disclosure. For example, the server 106 may run an operational-state inference engine 260, which identifies an operational state pattern for a vehicle, and possibly operational-state warning signs. The server 106 may receive activity records, such as operational data, maintenance record data, used oil analysis data, and location data, from the user devices, vehicles, and other data sources. This division of operating environment 100 is provided to illustrate one example of a suitable environment, and there is no requirement for each implementation that any combination of server 106 and user devices 102a and 102b through 102n, vehicles, or other data sources remain as separate entities.

User devices 102a and 102b through 102n may comprise any type of computing device capable of use by a user. The technology described herein uses signals from user devices of users associated with a vehicle to determine a vehicle's operational state. As described subsequently, the user device signals can be combined with other signals to determine the operational state. For example, in one aspect, user devices 102a through 102n may be the type of computing device described in relation to FIG. 7 herein. By way of example and not limitation, a user device may be embodied as a personal computer (PC), a laptop computer, a mobile device, a smartphone, a tablet computer, a smart watch, a wearable computer, a fitness tracker, a virtual reality headset, augmented reality glasses, a personal digital assistant (PDA), an MP3 player, a global positioning system (GPS) or device, a handheld communications device, or system, an entertainment system, a scanner (e.g., barcode scanner), a consumer electronic device, a workstation, a vehicle telematics system, vehicle data logger, electronic control unit (ECU) in a vehicle, or any combination of these delineated devices, or any other suitable device.

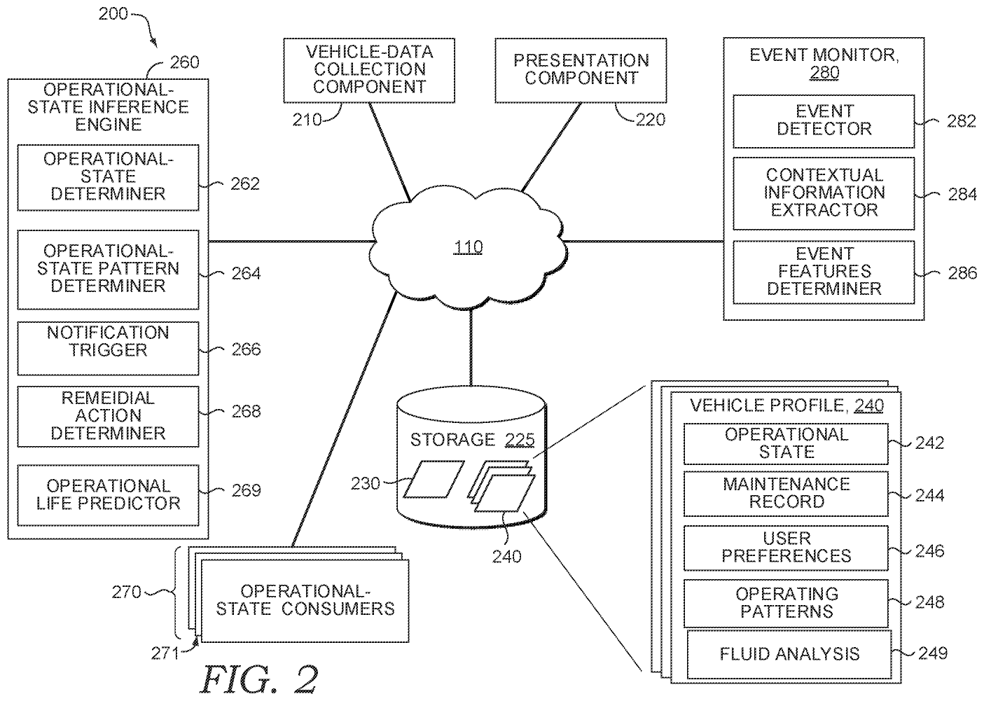

Data sources 104a and 104b through 104n may comprise data sources and/or data systems, which are configured to make data available to any of the various constituents of operating environment 100, or system 200 described in connection to FIG. 2. (For example, in one aspect, one or more data sources 104a through 104n provide (or make available for accessing) vehicle data, including maintenance and repair and used oil analysis records, to vehicle-data collection component 210 of FIG. 2.) Data sources 104a and 104b through 104n may be discrete from user devices 102a and 102b through 102n and vehicles 103a and 103b through 103n and server 106. The data sources 104a through 104n can receive information from sensors on user devices 102a and 102b through 102n and vehicles 103a and 103b through 103n and store the data for subsequent analysis. The data sources 104a through 104n can comprise a knowledge base that stores information about a vehicle, a user, or other entity related to a particular vehicle's operational state.

Vehicles 103a and 103b through 103n can be cars, trucks, motorcycles, boats, scooters, or any other mobile machine powered by an engine. An engine can be an electric engine or a combustion engine. The vehicles can be part of a fleet, such as a fleet of rental cars, delivery trucks, city buses, police cars, fire engines, ambulances, and the like. A fleet of vehicles is under common operational control by an entity, such as a company or government entity. The vehicles can have onboard sensors and computing systems that collect data about the vehicle. Exemplary vehicle sensors include, but are not limited to, Air flow meter, Air-fuel ratio meter, AFR sensor, blind spot monitor, crankshaft position sensor, curb feeler, DPF sensor, engine coolant temperature sensor, wheel speed sensor, airbag sensors, automatic transmission speed sensor, camshaft position sensor, crankshaft position sensor, coolant temperature sensor, fuel level sensor, fuel pressure sensor, knock sensor, light sensor, MAP sensor, mass airflow sensor, oil level sensor, oil pressure sensor, oxygen sensor, radar sensor, speed sensor, speedometer, throttle position sensor, tire pressure sensor, torque sensor, transmission fluid temperature sensor (e.g., level, temperature, pressure), vehicle speed sensor, wheel speed sensor, and water-in-fuel sensor.

These sensors can help measure a vehicle's state. For example, a DPF (Diesel Particulate Filter) sensor measures the differential pressure in the exhaust gas before and after the DPF. Alternatively, the DPF can compare the exhaust gas pressure before the DPF with atmospheric pressure. A high difference can indicate a problem with the exhaust system. However, the DPF reading can also be a proxy for other problems with the vehicle that might fail in correlation with the exhaust system or cause the exhaust system to be clogged, such as a malfunctioning fuel injector.

A crankshaft sensor measures the speed, rotation, and position of the crankshaft. Exemplary crankshaft sensors can include Hall-effect and VRS (Variable Reluctance Sensor) types. The crankshaft sensor can be used in combination with other data to determine whether the engine is injecting fuel at the optimal moment. A camshaft sensor measures the position of the camshaft during its rotation. The camshaft data can be used to determine a position of each valve. This data can be used to optimize fuel injection and sparking (for gasoline engines). Exemplary camshaft sensors can include Hall-effect and VRS (Variable Reluctance Sensor) types.

The temperature sensors can include an outdoor temperature sensor, an exhaust system temperature sensor, an air-intake temperature sensor, a coolant temperature sensor, and an oil temperature sensor, among other examples.

The fuel pressure sensor can measure the fuel pressure near an injection point, such as an injection manifold. A mass air flow (MAF) sensor is located near the air filter and monitors the amount of air that enters the engine. The oxygen sensor is usually located near the exhaust manifold and after the catalytic convertor. The oxygen sensor (or O2 sensor) monitors the content of oxygen in the exhaust gases. The information can be used to detect whether the engine is running a rich fuel ratio or a lean one.

These sensors and others can provide sensor readings to a vehicle computer that collects the data for analysis. The vehicle computer can be an electronic control unit (ECU) or work with one or more ECUs. An ECU is any embedded system in automotive electronics that controls one or more of the electrical systems or subsystems in a vehicle. A single vehicle can have dozens of ECUs, each with a system to control. The vehicle computer described herein can include the ECUs or be completely separate. For example, the ECUs may receive signal data from the sensors and the vehicle computer could also receive the same sensor data. The vehicle computer communicates some or all of the sensor data to the data sources (e.g., data source 104a) and/or vehicle-data collection component 210.

The technology described herein can be used on personal vehicles. For example, the vehicles 103a and 103b through 103n include vehicles by individuals. The individuals may subscribe to a maintenance monitoring service that is enabled by technology described herein. The maintenance monitoring service can be provided by a dealership, a maintenance organization, a vehicle manufacturer, a network of gas stations, or other organizations. Owners of the vehicles can provide authorization to use data collected to generate maintenance recommendations/predictions for their own vehicle as well as recommendations for other vehicles. The data collected can also provide remaining useful life for various components of the vehicle/asset and optimize maintenance of said vehicle/asset in order to increase the uptime of the vehicle and earnings/profits of its owner/company.

Operating environment 100 can be utilized to implement one or more of the components of system 200, described in FIG. 2, including components for collecting vehicle data, identifying events associated with an operational state, inferring operational-state patterns and baselines, and detecting operational-state warning signs.

Referring now to FIG. 2, with FIG. 1, a block diagram is provided showing aspects of an example computing system architecture suitable for generating maintenance recommendations and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively couples components of system 200 including vehicle-data collection component 210, presentation component 220, event monitor 280, operational-state inference engine 260, operational-state consumers 270, and storage 225. Event monitor 280 (including its components 282, 284, and 286), operational-state inference engine 260 (including its components 262, 264, 266, 268, and 269), vehicle-data collection component 210, presentation component 220, and operational-state consumers 270 may be embodied as a set of compiled computer instructions or functions, program modules, computer software services, or an arrangement of processes carried out on one or more computer systems, such as computing device 700 described in connection to FIG. 7, for example.

In one aspect, the functions performed by components of system 200 are associated with one or more applications, services, or routines. In particular, such applications, services, or routines may operate on one or more user devices (such as user device 102a), vehicles (such as vehicle 103a), servers (such as server 106), may be distributed across one or more user devices, vehicles, and servers, or be implemented in the cloud. Moreover, in some aspects, these components of system 200 may be distributed across a network, including one or more servers (such as server 106), vehicles (such as vehicle 103a), and client devices (such as user device 102a), in the cloud, or may reside on a user device, such as user device 102a. Moreover, these components, functions performed by these components, or services carried out by these components may be implemented at appropriate abstraction layer(s), such as the operating system layer, application layer, hardware layer, etc., of the computing system(s). Alternatively, or in addition, the functionality of these components and/or the aspects described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 200, it is contemplated that in some aspects functionality of these components can be shared or distributed across other components.

Continuing with FIG. 2, vehicle-data collection component 210 is generally responsible for accessing or receiving (and in some cases also identifying) vehicle data from one or more data sources, such as data sources 104a and 104b through 104n and vehicles 103a and 103b through 103n of FIG. 1. In some aspects, vehicle-data collection component 210 may be employed to facilitate the accumulation of vehicle data of a particular vehicle (or in some cases, a plurality of vehicles including crowdsourced data) for event monitor 280, operational-state inference engine 260, or an operational-state consumer 270. The data may be received (or accessed), and optionally accumulated, reformatted, and/or combined, by vehicle-data collection component 210 and stored in one or more data stores, such as storage 225, where it may be available to other components of system 200. For example, the vehicle data may be stored in or associated with a vehicle profile 240, as described herein.

Vehicle data may be received from a variety of sources where the data may be available in a variety of formats. For example, in some aspects, vehicle data received via vehicle-data collection component 210 may be determined via one or more sensors, which may be on or associated with one or more vehicles (such as vehicle 103a), user devices (such as user device 102a), servers (such as server 106), and/or other computing devices. As used herein, a sensor may include a function, routine, component, or combination thereof for sensing, detecting, or otherwise obtaining information, such as vehicle data, and may be embodied as hardware, software, or both. By way of example and not limitation, vehicle data received may include data that is sensed or determined from one or more sensors (referred to herein as sensor data). Vehicle data collected by a user device can include sensor data such as location information of mobile device(s), properties or characteristics of the user device(s) (such as device state, charging data, date/time, or other information derived from a user device such as a mobile device), user-activity information (for example: app usage; online activity; searches; voice data such as automatic speech recognition; activity logs; communications data including calls, texts, instant messages, and emails; website posts; other vehicle-data associated with communication events; etc.), global positioning system (GPS) data, traffic data, weather data (including forecasts), wearable device data, other user device data (which may include device settings, profiles, network-related information (e.g., network name or ID, domain information, work group information, connection data, Wi-Fi network data, or configuration data, data regarding the model number, firmware, or equipment, device pairings, such as where a user has a mobile phone paired with a Bluetooth headset, for example, or other network-related information)), gyroscope data, accelerometer data, other sensor data that may be sensed or otherwise detected by a sensor (or other detector) component(s) including data derived from a sensor component associated with the vehicle (including location, motion, orientation, position, user-access, user-activity, network-access, user-device-charging, or other data that is capable of being provided by one or more sensor component), data derived based on other data (for example, location data that can be derived from Wi-Fi, Cellular network, or IP address data), and nearly any other source of data that may be sensed or determined as described herein.

The vehicle information can include information received from a vehicle computer, such as described previously with reference to FIG. 1. Vehicle data can also include fluid analysis records, such as analysis results of lubricants, coolants, and/or other fluids removed from a vehicle. The fluid may be removed for the express purpose of analysis or as part of routine maintenance. For example, the oil removed from a vehicle during an oil change can be tested upon removal. Representative fluid parameters analyzed can include lead content, water content, iron content, aluminum content, sodium content, copper content, silicon content, chromium content, titanium content, tin content, zinc content, nickel content, potassium, calcium, phosphorus, sulfur, and vanadium content. The oil can also be analyzed for oxidation, viscosity, soot content, water content, and the oil's ability to neutralize acids. The analysis results can be stored in a fluid analysis store 249 within a vehicle profile 240.

The signals can also be from maintenance records, including analysis/replacement/repair of parts (e.g., tires, brake pads). The maintenance data can be stored as maintenance events. Each maintenance event can be assigned an identification code (e.g., VMRS code) that describes the maintenance event, the date, duration (i.e., total downtime), expense, and explanation of maintenance performed, including a record of measured vehicle parameters at the time of the event (such as odometer reading). The associated contextual data for each maintenance event can also be applied to the analyzed parameters of the removed fluids, such as an analysis of oil sampled from a vehicle. The maintenance events can be stored in maintenance record store 244 of the vehicle profile 240.

In some respects, vehicle data may be provided in vehicle-data streams or signals. An on board fluid property sensor, such as an oil health monitor, can measure the fluid (e.g., oil) viscosity and other characteristics (e.g., acid level, soot level, coolant/water concentration). A “vehicle signal” can be a feed or stream of vehicle data from a corresponding data source. For example, a vehicle signal could be from a smartphone, a GPS device (e.g., for location coordinates), a vehicle-sensor device (e.g., temperature sensor, oxygen sensor, vibration sensor, pressure sensor, fluid characteristic sensor), a vehicle telematics system, a wearable device, a user device, a gyroscope sensor, an accelerometer sensor, a calendar service, an email account, a credit card account (e.g., describing a gas purchase), or other data sources. In some aspects, vehicle-data collection component 210 receives or accesses data continuously, periodically, or as needed.

The vehicle data and event data derived from it can be stored in storage 225. The storage 225 can include multi-vehicle records 230 and vehicle profiles. The multi-vehicle records can include use patterns, maintenance patterns, operational-state patterns, and other data derived from multiple vehicles. Each vehicle profile 240 collects information about a single vehicle. The multi-vehicle records can include descriptions or classifications of different environmental conditions encountered by a vehicle in a fleet. For example, road conditions, traffic patterns, and weather conditions encountered by different vehicles at different times can be gathered in the multi-vehicle data store. Data can be preprocessed on vehicle-data collection component 210.

The vehicle data and conclusions from analysis of data from a single vehicle may be stored in a vehicle profile 240. The vehicle profile 240 allows information from a single vehicle to be viewed, analyzed, edited, or otherwise accessed. The vehicle profile can include an operational state data store 242, maintenance record store 244, user preferences data store 246, operating patterns store 248, and fluid analysis store 249. The user preferences data store can include notification preferences and information, such as phone numbers, emails addresses, etc.

Event monitor 280 is generally responsible for monitoring vehicle data for information that may be used for identifying and defining operational-state events, which may include identifying and/or tracking features (sometimes referred to herein as “variables”) or other information regarding specific vehicle data and related contextual information. An operational-state event can be used as input to calculate an operational-state score. The events can include operational events, maintenance events, oil analysis events, and status events. Other types of events are possible. The operational events can include external conditions experienced by the vehicle and describe how the overall vehicle was used. The status events are based on internal vehicle performance measures, such as fluid characteristics, detected vibrations, sounds, or other directly measured vehicle characteristics. Oil analysis events include the results of an analysis of a vehicle's oil. The oil may be taken from the vehicle in a sample or tested while in the vehicle. Maintenance events describe repairs or adjustments made to the vehicle. Maintenance events can also include inspection results even when no changes are made.

The event's occurrence and details can be derived from the vehicle data. For example, GPS data, speedometer readings, and data from a driver's phone may be used to determine a heavy traffic event. The heavy traffic event can be identified using an event definition comprising different signal characteristics that would be found if a heavy traffic event was experienced. When all characteristics of an event are present within the signals then the event can be recorded. For example, a heavy traffic event can occur when the vehicle engine is running for longer than a designated duration, staying below a designated speed, and while GPS data indicates the vehicle is on a road.

Using events, instead of actual data as input, can simplify the process of calculating a score by providing a more uniform input across vehicles and situations. An event can be for a single monitored variable, such as whether the vehicle's engine was operating. In this case, an engine operation event could be created to indicate when the engine was turned on and turned off. The single event allows a machine learning algorithm to process a single event rather than a series of engine status records. In another example, an event is only created when a particular characteristic of a vehicle goes outside of an expected normal operating range. For example, a vibration event could be created when a vibration sensor detects a vibration signal outside of the normal range.

Aspects of event monitor 280 may determine, from the monitored vehicle data, when the vehicle participates in an event that may impact operational state. Exemplary events include cold and hot weather events, heavy load events, inclement weather events, heavy traffic events, dirt road events, rough road events, skids, traction loss, rapid acceleration, rapid deceleration, low fuel event, low tire pressure event, high tire pressure event, or other events relevant to operational state. In other words, the event monitor 280 may receive vehicle data and generate event data. The event data can then be used to calculate an operational-state score for the vehicle.

Event monitor 280 may identify current or near-real-time event information and may also identify historical event information, in some aspects, which may be determined based on gathering observations of vehicle data over time, accessing user logs of past event data (such as a maintenance event data). User logs can be generated by maintenance managers, fleet owners, mechanics, drivers, etc.

Further, in some aspects, event monitor 280 may identify events (which may include historical events) from other similar vehicles (i.e., crowdsourcing), as described previously. For example, vehicle information from other vehicles co-located with the vehicle during a potential heavy traffic event may be analyzed to determine the heavy traffic event occurred. Alternatively, the vehicle information from co-located users could be used to determine the intensity of a rough road event when vehicle information about a co-located vehicle is not available during the event. For example, different vehicles may have different sensor data available. The sensor data from one vehicle may be used to determine environmental conditions experienced by another vehicle.

In some aspects, information determined by event monitor 280 may be provided to operational-state inference engine 260 including information regarding the current context and historical events (historical observations). Some aspects may also provide operational-state information, such as probable upcoming usage patterns, for example, based on a delivery schedule, to one or more operational-state consumers 270.

As described previously, operational-state event features may be determined by monitoring vehicle data received from vehicle-data collection component 210. In some aspects, the vehicle data and/or information about the operational state determined from the vehicle data is stored in a vehicle profile, such as vehicle profile 240. Each vehicle in a fleet may have a unique vehicle profile 240. The vehicle profile 240 is an electronic record of various information about the vehicle and, potentially, the vehicle's driver(s), operation, maintenance history, and such.

As shown in example system 200, event monitor 280 comprises an event detector 282, contextual information extractor 284, and an event features determiner 286. In some aspects, event monitor 280, one or more of its subcomponents, or other components of system 200, such as operational-state consumers 270 or operational-state inference engine 260, may determine interpretive data from received vehicle data. Interpretive data corresponds to data utilized by these components of system 200 or subcomponents of event monitor 280 to interpret vehicle data. For example, interpretive data can be used to provide other context to vehicle data, which can support determinations or inferences made by the components or subcomponents. Moreover, it is contemplated that aspects of event monitor 280, its subcomponents, and other components of system 200 may use vehicle data and/or vehicle data in combination with interpretive data for carrying out the objectives of the subcomponents described herein. Additionally, although several examples of how event monitor 280 and its subcomponents may identify event information are described herein, many variations of event identification and event monitoring are possible in various aspects.

Event detector 282, in general, is responsible for determining (or identifying) an operational-state-related event for the vehicle by analyzing vehicle data. Aspects of event detector 282 may be used for determining a type of event occurred. Various event logic can be used to determine that some events occurred. For example, a hot engine event logic could evaluate vehicle data to identify when an engine reached a threshold temperature and when the engine temperature fell below said threshold.

Additionally, some aspects of event detector 282 extract from the vehicle data information about events relevant to operational state, which may include current events, historical events, and/or related information, such as contextual information. (Alternatively or in addition, in some aspects, contextual information extractor 284 determines and extracts contextual information that is related to one or more events. Similarly, in some aspects, event features determiner 286 extracts information about events based on an identification of the event determined by event detector 282.) Examples of extracted event information may include location information, movement information, traffic data, weather data, etc., or nearly any other data related to events. Among other components of system 200, the extracted event information determined by event detector 282 may be provided to other subcomponents of event monitor 280, operational-state inference engine 260, or one or more operational-state consumers 270.

In some aspects, the operational-state-related features may be interpreted by a machine classification process to determine an operational-state-related event has occurred. For example, in some aspects, event detector 282 employs event logic, which may include rules, conditions, and/or associations, to identify or classify events. The classifying of events (e.g., hot engine, dirty air, heavy traffic, heavy load, rough road, bad turbo, faulty tire, over-pressurized fuel pump) can be based on feature-matching or determining similarity in features, which falls under pattern recognition. This type of classification may use pattern recognition, fuzzy logic, neural network, finite state machine, support vector machine, logistic regression, clustering, random forest, or a variety of other machine learning techniques, similar statistical classification processes, or combinations of these to identify events from vehicle data. For example, operation anomaly logic may specify types of vehicle information that are associated with an overload event, such as engine RPMs staying a threshold amount above a baseline for a designated duration, in combination with location or movement data. Different patterns of activity may be mapped to different events. For example, heavy traffic, rough road, hot engine, inclement weather, turbo failure, fuel pump over-pressurization, and reckless driving events may all have different activity patterns.

Contextual information extractor 284, in general, is responsible for determining contextual information related to the events, such as context features or variables associated with an event, related information, and is further responsible for associating the determined contextual information with the detected event. In some aspects, contextual information extractor 284 may associate the determined contextual information with the related event and may also log the contextual information with the associated event. Some aspects of contextual information extractor 284 determine contextual information related to an event such as entities related to the event (e.g., other people or vehicles present during the event) or the location where the event took place. By way of example and not limitation, this may include context features such as location data, which may be represented as a location stamp associated with the event; contextual information about the location, time, day, and/or date, which may be represented as a time stamp associated with the event; duration of the event; other events preceding and/or following the events; other information about the event such as entities associated with the event (e.g., venues, people, objects); and information detected by sensor(s) on user devices associated with the user that is concurrent or substantially concurrent to the event.

In aspects using contextual information related to a vehicle, a vehicle may be identified by detecting and analyzing characteristics of the vehicle computer, such as device hardware, software such as operating system (OS), network-related characteristics, and similar characteristics. For example, information about a vehicle may be determined using functionality of many operating systems to provide information about the hardware, OS version, network connection information, installed application, or the like. In some aspects, a vehicle name or identification (device ID) may be determined for each vehicle. This information about the identified vehicle may be stored in a vehicle profile associated with the vehicle, such as in vehicle profile 240. In an aspect, the vehicles may be polled, interrogated, or otherwise analyzed to determine contextual information about the vehicles. This information may be used for determining a label or identification of the vehicle (e.g., a vehicle ID) so that contextual information about an event captured on one vehicle may be recognized and distinguished from data captured by another vehicle.

Event features determiner 286 is generally responsible for determining operational-state-related features (or variables) associated with an event that may be used for identifying patterns of operational state. Operational-state features may be determined from information about an event and/or from related contextual information. In some aspects, event features determiner 286 receives information from event monitor 280 (or its subcomponents) and analyzes the received information to determine a set of zero or more features associated with the operational-state event. Common features for different events can be used to help establish an operational-state pattern.

Examples of operational-state-related features include, without limitation, location-related features, such as location of the user device(s) during the event, venue-related information associated with the location, or other location-related information; time-related features, such as time(s) of day(s), day of week or month of the event, or the duration of the event, or related duration information, such as how long the vehicle was overloaded, or position/motion/orientation-related information about the vehicle.

Continuing with system 200 of FIG. 2, operational-state inference engine 260 is generally responsible for determining operational-state scores and patterns based on the operational-state event information determined from event monitor 280. In addition to or instead of event information, the inference engine 260 can directly use raw vehicle data to identify maintenance activities that can help the vehicle return to a baseline operational state. In some aspects, operational-state inference engine 260 may run on a server, as a distributed application across multiple devices, or in the cloud. At a high level, operational-state inference engine 260 may receive operational-state-related information, for example, from vehicle-data collection component 210.

One or more inference algorithms may be applied to the operational-state-related information to determine a set of operational-state scores. In some aspects, a corresponding confidence level/percent/interval for the score is also determined. For example, a vehicle with a large amount of data may receive an operational-state score with a higher confidence level/percent/interval than a vehicle with less data. Additionally, some vehicle data is effectively given more weight than other data when calculating a score because of more accurate sensors, relevancy as a predictor, or some other factor. A vehicle having data given more weight may have a higher confidence score than a vehicle having data given less weight. The operational-state pattern may comprise operational state over a period of time.

As shown in example system 200, operational-state inference engine 260 comprises operational-state determiner 262, operational-state pattern determiner 264, notification trigger 266, remedial action determiner 268, and operational-life predictor 269.

Operational-state determiner 262 receives vehicle data and generates an operational-state score. The operational-state determiner 262 can generate operational-state scores periodically, such as hourly, daily, weekly, or further out in time. The operational-state score can be generated heuristically or by using machine learning, such as a specially trained machine classifier. The heuristic approach can assign a value to a variable based on operating measurements and events derived from the vehicle data. For example, a vehicle's operational-state score could start at 100 directly after a maintenance event and decrease based on mileage. The severity of the duty cycle could cause the score for one vehicle to decrease more than another vehicle that drove the same miles since a maintenance event. For example, the detection of a cold weather event for a first vehicle could cause the operational-state score to decrease for the first vehicle more than the score decreases for a second vehicle that did not experience the cold weather event, all else being equal.

A classifier could be trained to receive vehicle data and classify the vehicle into an operational-state category, which is associated with a score. Generally, the classifier can be trained by inputting representative vehicle data into the classifier and forcing the classifier to calculate a specific score. For example, a batch of vehicle data could be input to the classifier and constrained with an operational-state score of seven. A second batch of vehicle data could be input to the classifier and constrained to an operational-state score of five. This process can be repeated until the nodes or features of the classifier are assigned values that result in a similar operational state being calculated when similar unlabeled vehicle data is input. Once trained, the classifier can receive vehicle data and generate a classification in the form of an operational-state score. The operational-state score can be associated with a confidence factor that is also derived from the input. The classifier can receive a large range of values for different vehicle data associated with different variables. In some instances, no data will be available for various variables. The difference in the amount of data and type of data as well as the values associated with the data can cause different classifications and confidence scores. In some instances, the confidence score can determine how the operational-state inference engine 260 uses individual operational-state scores. For example, scores associated with a low confidence value could be excluded from notifications, as described subsequently. A threshold confidence score may be established by users of the system, such as a fleet manager.

Operational-state pattern determiner 264 is generally responsible for determining an operational-state pattern based on individual operational-state scores. In particular, operational-state pattern determiner 264 (or operational-state inference engine 260) may determine an operational-state pattern based on the repetition of similar operational-state scores associated with the same time stamp. An operational-state pattern comprises a series of representative operational-state scores in a similar framework that allows comparison. Each representative score is for a particular point within the framework. A point in time could be a day of the week, a time of day, and such. Points in time can also be relative to a maintenance event, such as oil changes, tire rotations, tune ups, and such. As an alternative to time, the framework could be based on miles traveled, or hours of operation for a vehicle. The general pattern can be a decrease in operational-state score over time between maintenance operations and as the vehicle ages.

In some aspects, the output of operational-state pattern determiner 264 may be stored as operational-state patterns in vehicle profile 240 and in some aspects may be provided to an operational-state consumer 270.

Operational-state notification trigger 266 detects operational-state score in a notification threshold. A notification can be sent to a driver, fleet manager, or other user of the system.

Remedial-activity determiner 268 determines one or more activities that may help the vehicle recover operational state. The maintenance event can be determined for the vehicle by analyzing vehicle data associated with a plurality of vehicles which returned to acceptable operational-state scores after experiencing a low operational-state score. In order to determine the remedial activity, operational state patterns for a plurality of vehicles can be generated and correlated with operational-state scores for the plurality of vehicles. The vehicle information can be used to identify vehicles within the plurality of vehicles that are similarly situated to the individual vehicle experiencing a poor operational state. For example, the remedial activity for a 5 year old truck used for long haul delivery could be derived by analyzing activity patterns of other 5 year old trucks used for similar long haul delivery (e.g., matching similar duty cycle profiles). The remedial activity can be a change in a driver behavior, a repair or replacement operation, a routing issue, a usage change, or other suggestion.

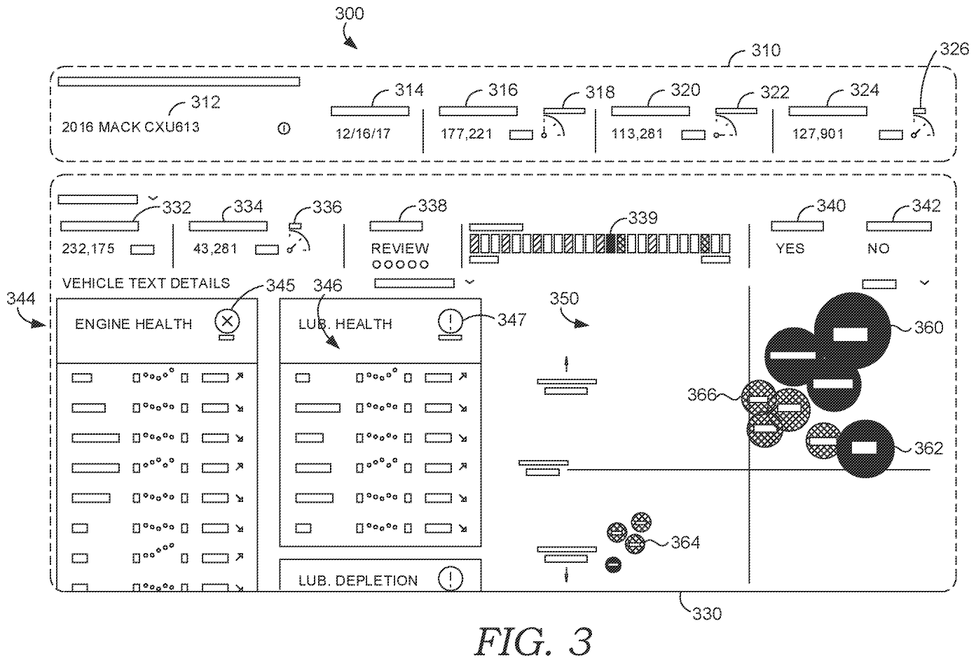

Presentation component 220 can communicate an operational-state warning to the driver, fleet manager, or other user along with a recommended maintenance activity that may return the operational state of the vehicle to a satisfactory level. In addition, the presentation component 220 can provide historical operational-state scores for the vehicle along with recent scores and other specific analysis, such as the result of an analysis on oil removed from the vehicle. An exemplary interface is described with reference to FIG. 3. The notification can include an operational life estimate generated by the operational-life predictor 269.

The operational-life predictor 269 estimates an amount of operational life left before the failure of a component passes above a threshold by which failure is likely to occur. For example, the operational-life predictor 269 may indicate that a vehicle can be driven for 5,000 more miles before a timing chain has above a 90% likelihood of breaking. As an alternative to miles, the time to failure could be expressed in terms of hours of operation or some other measure appropriate for the vehicle.

The operational-life predictor 269 can use machine learning to calculate the amount of service left before failure. The operational-life predictor 269 can be trained using vehicle data, including event data described previously, for the vehicle. The maintenance events and/or maintenance data in the vehicle data can indicate what type of failures occurred and when the failures occurred. The vehicle data used to calculate the operational state of a vehicle can be correlated to the observed failures in the maintenance data. Machine learning can be used to determine a likelihood of a failure occurring given observed vehicle data pointing to failure. The operational-life predictor 269 can establish a correlation between captured vehicle data and a failure. In one aspect, the machine learning is a decision tree, neural network, a linear regression, or some other method.

Continuing with FIG. 2, example system 200 includes one or more operational-state consumers 270, which comprise applications or services that consume operational-state score information to provide improved vehicle performance. The operational-state score may be provided to the operational-state consumers 270 through an application program interface (API). Examples of operational-state consumer 270 may include, without limitation, fleet managers, original equipment manufacturers, lubricant distributors, fleet drivers, fleet owners, maintenance providers, installation shops, and such.

Turning now to FIG. 3, an operational-state interface 300 is shown. The operational-state interface 300 includes a vehicle overview section 310 and an analysis detail portion 330. The vehicle overview section 310 includes a vehicle identification field 312 that uniquely identifies a vehicle to a user. In one aspect, a VIN number for the vehicle could be inserted into the identification field 312. In other implementations, the make and model of the vehicle can be used along with an identifier that distinguishes it from other vehicles in a fleet of the same make and model.

The vehicle overview section 310 includes a next-suggested-service-date field 314 and an oil-change interval field 316. The interval evaluation indicator 316 indicates whether or not the interval is above or below a recommended interval. The oil filter change field 320 indicates the vehicle mileage between the oil filter changes. The oil filter interval indicator 322 indicates whether the interval is in a recommended range or not. The sample interval field 324 indicates the interval between taking oil samples. The sample-interval health indicator 326 shows whether the sample interval is within a recommended range.

The analysis detail portion 330 provides details about a selected analysis along with trends from previous analysis or subsequent analysis, as available. The vehicle age field 332 indicates how many miles were on the vehicle at the time the fluid sample was taken. The fluid age field 334 indicates how many miles the sampled fluid was in the vehicle. The operational-state indicator 336 communicates an operational state of the vehicle. An abnormal analysis result can indicate a low operational state of a vehicle. The miles bar 338 indicates an overall mileage for the vehicle and also shows fluid sampling events in relationship to overall mileage. The fluid sampling events 339 can be color-coded to communicate the operational state of the vehicle at the time of the sampling event. Alternatively, the color-coded bars can communicate whether the analysis results were positive, neutral, or negative, without regard to the overall operational state of the vehicle. The oil-change indicator 340 communicates whether the display sample results are from oil that was changed, in contrast to simply sampling the oil. The oil filter indicator 342 indicates whether the oil filter was changed at the time the sample was taken.

The engine health section 344 shows metal levels detected in the fluid. Higher than normal concentrations of certain metals could indicate an engine problem. The engine health section 344 can show trends from previous samples. An overall engine health indicator 345 can communicate the operational state of the engine, in isolation from the overall operational state of the entire vehicle. Of course, the operational state of the engine is a component of the overall operational state of the vehicle. But as mentioned, the technology described here in can calculate operational-state scores for individual vehicle components.

The lubricant health section 346 shows various characteristics of the lubricant. The characteristics can include constituents in the lubricant, such as possible lubricant contaminants. The characteristics can also include lubricant properties, such as viscosity. The lubricant health section 346 shows trends in previous sample results. The overall lubricant health indicator 347 provides an operational state of the lubricant.

The fluid content graph 350 visually depicts the amount of various components found in the sample along with trends. The amount of individual samples as indicated by the size of the circle. For example, the lead circle 360 is larger than the iron circle 362. This communicates that more lead was found in the sample than iron. The red color of both the lead circle 360 and the iron circle 362 indicates that the lead and iron content is above recommended levels. The orange color of the sodium circle 366 and the sulfur circle 364 indicates that the sodium and sulfur levels are within a normal range. The location of the circles on the fluid content graph 350 communicates a trend from previous samples. Circles in the top half of the graph 350 indicate that the corresponding constituent has increased from previous samples. Circles in the bottom half of the graph 350 indicate that the corresponding constituent has decreased from previous samples. Circles exactly in the middle would indicate that the amount of the constituent represented by the circle has remained unchanged.

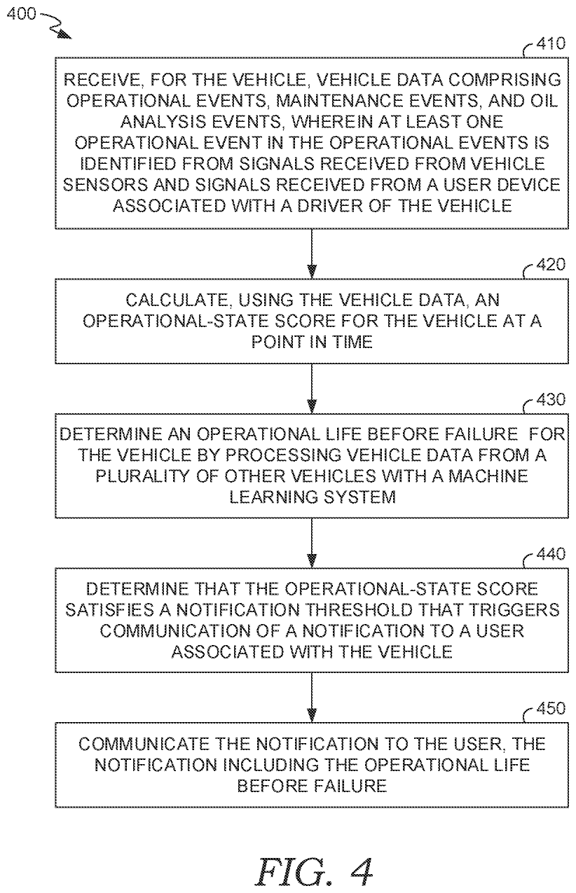

Turning now to FIG. 4, a method 400 of determining an operational state of a vehicle is provided. Method 400 can be performed by a computing system similar to system 200 described previously.

At step 410, vehicle data is received for the vehicle. The vehicle data comprises an operational event, a maintenance event, and an oil analysis event. The operational event is identified from signals received from vehicle sensors and signals received from a user device associated with a driver of the vehicle. The vehicle data can also include raw signal data from one or more sensors. Further, the vehicle data can include multiple events of various kinds.

The operational events can include external conditions experienced by the vehicle and describe how the overall vehicle was used. The status events are based on internal vehicle performance measures, such as fluid characteristics, detected vibrations, sounds, or other directly measured vehicle characteristics. Oil analysis events include the results of an analysis of a vehicle's oil. The oil may be taken from the vehicle in a sample or tested while in the vehicle. Maintenance events describe repairs or adjustments made to the vehicle. Maintenance events can also include inspection results.

At step 420, an operational-state score for the vehicle at a point in time is calculated using the vehicle data. Calculation of an operational-state score has been described previously with reference to the operational-state pattern determiner 264.

At step 430, an estimated operational life before failure for the vehicle is determined by processing vehicle data from a plurality of other vehicles with a machine learning system. In one aspect, the machine learning is a decision tree, neural network, a linear regression, or some other method. Determining an operational life before failure has been described previously with reference to the operational-life predictor 269.

At step 440, the operational-state score is determined to satisfy a notification threshold that triggers communication of a notification to a user associated with the vehicle. The operational-state score may be compared with the threshold in order to trigger the notification. The notification threshold can be set by a user of the system, such as a fleet manager. Information from the machine learning system can also be used to set the threshold, including the estimated service. In one aspect, the estimated operational life is used with the operational-state score to determine when a notification is sent. The user may be given the option of manually setting a threshold or adopting a threshold recommended by the machine learning system.

At step 450, a notification is communicated to the user. The notification includes the operational life before failure. The notification could be communicated through an email, text, or some other interface. The user can be the driver, fleet manager, maintenance manager, or some other person associated with the vehicle. Communications can be sent to multiple users.

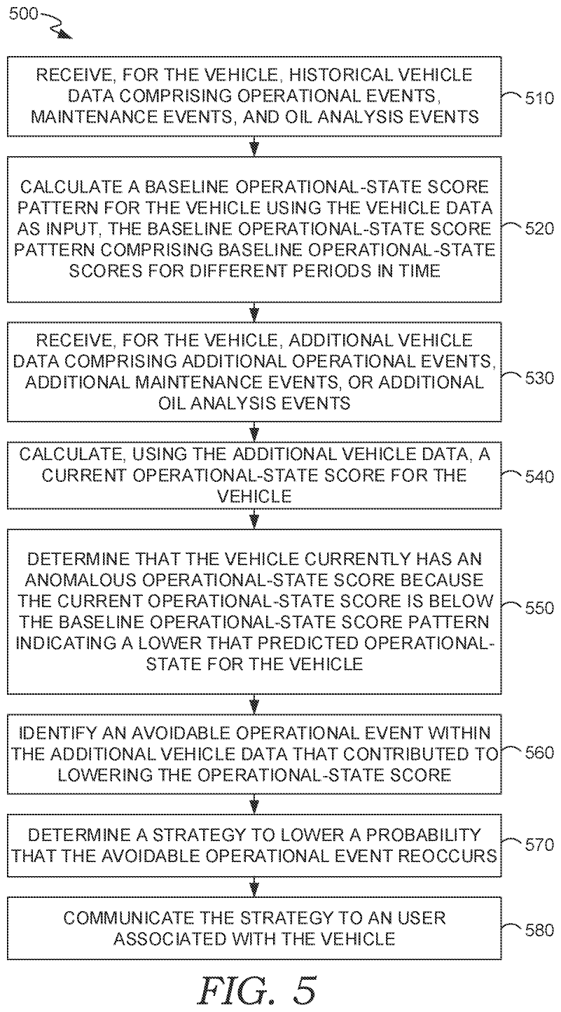

Turning now to FIG. 5, a method 500 of determining an operational state of a vehicle is provided. Method 500 can be performed by a computing system similar to system 200 described previously.

At step 510, vehicle data is received for the vehicle. The vehicle data comprises an operational event, a maintenance event, and an oil analysis event. The operational events can include external conditions experiences by the vehicle and describe how the overall vehicle was used. The status events are based on internal vehicle performance measures, such as fluid characteristics, detected vibrations, sounds, or other directly measured vehicle characteristics. Oil analysis events include the results of an analysis of a vehicle's oil. The oil may be taken from the vehicle in a sample or tested while in the vehicle. Maintenance events describe repairs or adjustments made to the vehicle. Maintenance events can also include inspection results.

At step 520, calculating a baseline operational-state score pattern for the vehicle using the vehicle data as input, the baseline operational-state score pattern comprising baseline operational-state scores for different periods in time. Calculation of an operational-state score has been described previously with reference to the operational-state pattern determiner 264. The baseline operational-state score pattern is a series of scores correlated to a framework such as hours of operation, miles driven, or some other measure of a duty cycle.

At step 530, receiving, for the vehicle, additional vehicle data comprising additional operational events, additional maintenance events, or additional oil analysis events. The baseline is calculated using historical vehicle information gathered over time. The additional data is for the present or recent past and will be used to calculate the current operational state of the vehicle.

At step 540, calculating, using the additional vehicle data, a current operational-state score for the vehicle. Calculation of an operational-state score has been described previously with reference to the operational-state pattern determiner 264.

At step 550, determining that the vehicle currently has an anomalous operational-state score because the current operational-state score is below the baseline operational-state score pattern indicating a lower than predicted operational-state score for the vehicle. The baseline operational-state score can be based on a duty cycle. In this case, the operational-state score is compared to the baseline score that corresponds to the vehicle's duty cycle. It is normal for the operational-state score to decrease through a vehicle's duty cycle. Comparing the current operational-state score with a baseline score that is correlated to the duty cycle helps detect anomalous states more accurately and avoid false positives. For example, the lubricants in a vehicle may deteriorate through its duty cycle. In absolute terms, the operational-state score will decrease as characteristics of the lubricants change for the worse with use. However, this is expected and should not be considered anomalous. Comparing the operational-state score of a vehicle 20,000 miles into its duty cycle against a baseline for the vehicle calculated at 20,000 miles will help determine when the deterioration is anomalous vs. expected.

At step 550, identifying an avoidable operational event within the additional vehicle data that contributed to the anomalous operational-state score. Remedial-activity determiner 268 describes one way to identify an avoidable operational event. Most often, the avoidable operational event will involve driver error or some other decision that could be changed. For example, it may not be possible to avoid cold weather, but it may be possible to avoid traffic by leaving at a different time of day or taking an alternate route.

At step 560, determining a strategy to lower a probability that the avoidable operational event reoccurs. In one aspect, a list of strategies are available to avoid various events. The strategy could be selected from the list and provided to a driver or other person associated with the vehicle, such as a fleet manager. For example, a driver could be reminded to start and stop less abruptly.

At step 570, communicating the strategy to a user associated with the vehicle. The strategy could be communicated through an email, text, or some other interface. The user can be the driver, fleet manager, maintenance manager, or some other person associated with the vehicle. Communications can be sent to multiple users.

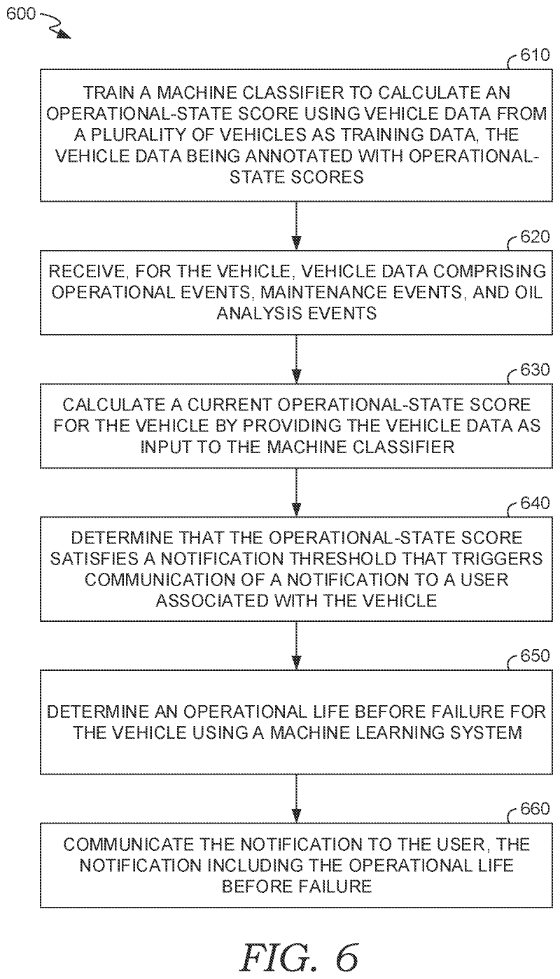

Turning now to FIG. 6, a method 600 of determining an operational state of a vehicle is provided. Method 600 can be performed by a computing system similar to system 200 described previously.

At step 610, a machine classifier is trained to calculate an operational-state score using vehicle data from a plurality of vehicles as training data. The vehicle data is annotated with operational-state scores.

At step 620, vehicle data comprising operational events, maintenance events, and oil analysis events is received for the vehicle. The operational events can include external conditions experienced by the vehicle and describe how the overall vehicle was used. The status events are based on internal vehicle performance measures, such as fluid characteristics, detected vibrations, sounds, or other directly measured vehicle characteristics. Oil analysis events include the results of an analysis of a vehicle's oil. The oil may be taken from the vehicle in a sample or tested while in the vehicle. Maintenance events describe repairs or adjustments made to the vehicle. Maintenance events can also include inspection results.

At step 630, a current operational-state score for the vehicle is calculated by providing the vehicle data as input to the machine classifier. Calculation of an operational-state score has been described previously with reference to the operational-state pattern determiner 264.

At step 640, the operational-state score is determined to satisfy a notification threshold that triggers communication of a notification to a user associated with the vehicle. The operational-state score may be compared with the threshold. The threshold can be set editorially.

At step 650, an operational life before failure for the vehicle is determined. In one aspect, the machine learning is a decision tree, neural network, a linear regression, or some other method. Determining an operational life before failure has been described previously with reference to the operational-life predictor 269.

At step 660, a notification is communicated to the user. The notification includes the operational life before failure. The notification could be communicated through an email, text, or some other interface. The user can be the driver, fleet manager, maintenance manager, or some other person associated with the vehicle. Communications can be sent to multiple users.

### Exemplary Operating Environment

Referring to the drawings in general, and initially to FIG. 7 in particular, an exemplary operating environment for implementing aspects of the technology described herein is shown and designated generally as computing device 700. Computing device 700 is but one example of a suitable computing environment and is not intended to suggest any limitation as to the scope of use of the technology described herein. Neither should the computing device 700 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant, smart phone, tablet, or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices located on a vehicle, vehicle telematics devices, etc. Aspects of the technology described herein may also be practiced in distributed computing environments where tasks are performed by remote-processing devices that are linked through a communications network.

With continued reference to FIG. 7, computing device 700 includes a bus 710 that directly or indirectly couples the following devices: memory 712, one or more processors 714, one or more presentation components 716, input/output (I/O) ports 717, I/O components 720, and an illustrative power supply 722. Bus 710 represents what may be one or more busses (such as an address bus, data bus, or a combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 7 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 7 and refer to “computer” or “computing device.”

Computing device 700 typically includes a variety of computer-readable media. Computer-readable media can be any available media that can be accessed by computing device 700 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, cellular, Bluetooth, Wi-Fi, NFC, infrared, and other wireless media. Combinations of any of the above should also be included within the scope of computer-readable media.

Memory 712 includes computer storage media in the form of volatile and/or nonvolatile memory. The memory 712 may be removable, non-removable, or a combination thereof. Exemplary memory includes solid-state memory, hard drives, optical-disc drives, etc. Computing device 700 includes one or more processors 714 that read data from various entities such as bus 710, memory 712, or I/O components 720. Presentation component(s) 716 present data indications to a user or other device. Exemplary presentation components 716 include a display device, speaker, printing component, vibrating component, etc. I/O ports 717 allow computing device 700 to be logically coupled to other devices, including I/O components 720, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 714 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 700. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

A computing device may include a radio 724. The radio 724 transmits and receives radio communications. The computing device may be a wireless terminal adapted to receive communications and media over various wireless networks. Computing device 700 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

### Embodiments

Embodiment 1. A method of determining an operational state of a vehicle comprising: receiving, for the vehicle, vehicle data comprising an operational event, a maintenance event, and an oil analysis event; calculating, using the vehicle data, an operational-state score for the vehicle at a point in time; determining an operational life before failure of the vehicle by processing vehicle data from a plurality of other vehicles with a machine learning system; determining that the operational-state score satisfies a notification threshold that triggers communication of a notification to a user associated with the vehicle; communicating the notification to the user, the notification including the operational life before failure.

Embodiment 2. The method of embodiment 1, wherein the operational event is identified from signals received from vehicle sensors and signals received from a user device associated with a driver of the vehicle.

Embodiment 3. The method as in any one of the preceding embodiments, further comprising: identifying an avoidable operational event that contributed to lowering the operational-state score; determining a strategy to lower a probability that the avoidable operational event reoccurs; and communicating the strategy to the user.

Embodiment 4. The method of embodiment 3, wherein the avoidable operational event includes a driver error.

Embodiment 5. The method as in any one of the preceding embodiments, wherein the machine learning system is a decision tree.

Embodiment 6. The method as in any one of the preceding embodiments, wherein the operational life before failure for the vehicle is determined by correlating observations in the vehicle data from the plurality of other vehicles to a recorded failure in the plurality of other vehicles.

Embodiment 7. The method as in any one of the preceding embodiments, wherein the oil analysis event is generated from analysis by an oil property sensor installed on the vehicle, or of a used oil sample measured from the vehicle in a laboratory, or from a vehicle on-site with specialized equipment.

Embodiment 8. A method of determining an operational state of a vehicle comprising: receiving, for the vehicle, historical vehicle data comprising an operational event, a maintenance event, and an oil analysis event; calculating a baseline operational-state score pattern for the vehicle using the historical vehicle data as input, the baseline operational-state score pattern comprising baseline operational-state scores for different periods in time; receiving, for the vehicle, additional vehicle data comprising additional operational events, additional maintenance events, or additional oil analysis events; calculating, using the additional vehicle data, a current operational-state score for the vehicle; determining that the vehicle currently has an anomalous operational-state score because the current operational-state score is below the baseline operational-state score pattern indicating a lower than predicted operational-state score for the vehicle; identifying an avoidable operational event within the additional vehicle data that contributed to the anomalous operational-state score; determining a strategy to lower a probability that the avoidable operational event reoccurs; and communicating the strategy to a user associated with the vehicle.

Embodiment 9. The method of embodiment 8, wherein the current operational-state score is calculated using a machine learning system.

Embodiment 10. The method as in any one of embodiments 8 and 9, wherein the avoidable operational event was an operational use of the vehicle.

Embodiment 11. The method as in any one of embodiments 8, 9, and 10, wherein the additional vehicle data comprises vehicle usage events derived from communication data associated with a driver of the vehicle through natural language processing of the communication data.

Embodiment 12. The method as in any one of embodiments 8, 9, 10, and 11, wherein the strategy includes more frequent monitoring of fluids in the vehicle.

Embodiment 13. The method as in any one of embodiments 8, 9, 10, 11, and 12, wherein the method further comprises continuing to monitor operational-state scores of the vehicle and determining that the strategy has not been followed and communicating a reminder to the user.

Embodiment 14. The method as in any one of embodiments 8, 9, 10, 11, 12, and 13, wherein the anomalous operational-state score is based, in part, on a change in constituent levels measured within a first oil sample removed from the vehicle at a first point in time and a second oil sample removed from the vehicle at a second point in time subsequent to the first point in time.

Embodiment 15. The method as in any one of embodiments 8, 9, 10, 11, 12, 13, and 14, further comprising outputting an interface that shows operational-state scores for the vehicle at different points in time.

Embodiment 16. A method of determining an operational state of a vehicle comprising: training a machine classifier to calculate an operational-state score using vehicle data from a plurality of vehicles as training data, the vehicle data being annotated with operational-state scores; receiving, for the vehicle, vehicle data comprising operational events, maintenance events, and oil analysis events; calculating a current operational-state score for the vehicle by providing the vehicle data as input to the machine classifier; determining that the operational-state score satisfies a notification threshold that triggers communication of a notification to a user associated with the vehicle; determining an operational life before failure for the vehicle using a machine learning system; and communicating the notification to the user, the notification including the operational life before failure.

Embodiment 17. The method of embodiment 16, further comprising generating the vehicle data by communicating a message to a computing device of a driver of the vehicle asking the driver to confirm that a detected maintenance-accelerating event occurred.

Embodiment 18. The method as in any one of embodiments 16 and 17, wherein the machine classifier is a neural network.

Embodiment 19. The method as in any one of embodiments 16, 17, and 18, further comprising: identifying an avoidable operational event within the vehicle data that contributed to lowering the operational-state score; determining a strategy to lower a probability that the avoidable operational event reoccurs; and communicating the strategy to the user.

Embodiment 20. The method as in any one of embodiments 16, 17, 18, and 19, wherein the vehicle data comprises an analysis of oil removed from the vehicle, wherein the analysis occurs at a laboratory or on-site with specialized equipment.

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

1. A method of determining an operational state of a vehicle comprising:
receiving, for the vehicle, vehicle data comprising an operational event, a maintenance event, and an oil analysis event; calculating, using the vehicle data, an operational-state score for the vehicle at a point in time; determining an operational life before failure of the vehicle by processing vehicle data from a plurality of other vehicles with a machine learning system; determining that the operational-state score satisfies a notification threshold that triggers communication of a notification to a user associated with the vehicle; communicating the notification to the user, the notification including the operational life before failure.

2. The method of claim 1, wherein the operational event is identified from signals received from vehicle sensors and signals received from a user device associated with a driver of the vehicle.

3. The method of claim 1,
further comprising: identifying an avoidable operational event that contributed to lowering the operational-state score; determining a strategy to lower a probability that the avoidable operational event reoccurs; and communicating the strategy to the user.

4. The method of claim 3, wherein the avoidable operational event includes a driver error.

5. The method of claim 1,
wherein the machine learning system is a decision tree.

6. The method of claim 1,
wherein the operational life before failure for the vehicle is determined by correlating observations in the vehicle data from the plurality of other vehicles to a recorded failure in the plurality of other vehicles.

7. The method of claim 1,
wherein the oil analysis event is generated from analysis by an oil property sensor installed on the vehicle, or of a used oil sample measured from the vehicle in a laboratory, or from a vehicle on-site with specialized equipment.

8. A method of determining an operational state of a vehicle comprising:
receiving, for the vehicle, historical vehicle data comprising an operational event, a maintenance event, and an oil analysis event; calculating a baseline operational-state score pattern for the vehicle using the historical vehicle data as input, the baseline operational-state score pattern comprising baseline operational-state scores for different periods in time; receiving, for the vehicle, additional vehicle data comprising additional operational events, additional maintenance events, or additional oil analysis events; calculating, using the additional vehicle data, a current operational-state score for the vehicle; determining that the vehicle currently has an anomalous operational-state score because the current operational-state score is below the baseline operational-state score pattern indicating a lower than predicted operational-state score for the vehicle; identifying an avoidable operational event within the additional vehicle data that contributed to the anomalous operational-state score; determining a strategy to lower a probability that the avoidable operational event reoccurs; and communicating the strategy to a user associated with the vehicle.

9. The method of claim 8, wherein the current operational-state score is calculated using a machine learning system.

10. The method of claim 8, wherein
the avoidable operational event was an operational use of the vehicle.

11. The method of claim 8,
wherein the additional vehicle data comprises vehicle usage events derived from communication data associated with a driver of the vehicle through natural language processing of the communication data.

12. The method of claim 8,
wherein the strategy includes more frequent monitoring of fluids in the vehicle.

13. The method of claim 8,
wherein the method further comprises continuing to monitor operational-state scores of the vehicle and determining that the strategy has not been followed and communicating a reminder to the user.

14. The method of claim 8,
wherein the anomalous operational-state score is based, in part, on a change in constituent levels measured within a first oil sample removed from the vehicle at a first point in time and a second oil sample removed from the vehicle at a second point in time subsequent to the first point in time.

15. The method of claim 8,
further comprising outputting an interface that shows operational-state scores for the vehicle at different points in time.

16. A method of determining an operational state of a vehicle comprising:
training a machine classifier to calculate an operational-state score using vehicle data from a plurality of vehicles as training data, the vehicle data being annotated with operational-state scores;
receiving, for the vehicle, vehicle data comprising operational events, maintenance events, and oil analysis events; calculating a current operational-state score for the vehicle by providing the vehicle data as input to the machine classifier; determining that the operational-state score satisfies a notification threshold that triggers communication of a notification to a user associated with the vehicle; determining an operational life before failure for the vehicle using a machine learning system; and communicating the notification to the user, the notification including the operational life before failure.

17. The method of claim 16, further comprising generating the vehicle data by communicating a message to a computing device of a driver of the vehicle asking the driver to confirm that a detected maintenance-accelerating event occurred.

18. The method of claim 16,
wherein the machine classifier is a neural network.

19. The method of claim 16,
further comprising: identifying an avoidable operational event within the vehicle data that contributed to lowering the operational-state score; determining a strategy to lower a probability that the avoidable operational event reoccurs; and communicating the strategy to the user.

20. The method of claim 16,
wherein the vehicle data comprises an analysis of oil removed from the vehicle, wherein the analysis occurs at a laboratory or on-site with specialized equipment.
